(19) United States
(12) Patent Application Publication
(10) Pub. No.: US 2009/0041316 A1
(43) Pub. Date: Feb. 12, 2009

(54) VIBRATOME ASSISTED SUBSURFACE IMAGING MICROSCOPY (VIBRA-SSIM)

(75) Inventors: David S. Koos, Pasadena, CA (US); Scott E. Fraser, LaCanada-Flintridge, CA (US)

Correspondence Address: GATES & COOPER LLP;HOWARD HUGHES CENTER, 6701 CENTER DRIVE WEST, SUITE 1050, LOS ANGELES, CA, 90045, US

(73) Assignee: CALIFORNIA INSTITUTE OF TECHNOLOGY, Pasadena, CA (US)

(21) Appl. No.: 12/188,076

(22) Filed: Aug. 7, 2008

Related U.S. Application Data
(60) Provisional application No. 60/963,763, filed on Aug. 7, 2007.

(51) Int. Cl. G06K 9/00

(52) U.S. Cl. 382/128; 382/133

(57) ABSTRACT

An system and method provide the ability to image a biological sample. A sample is embed to a support matrix that is compatible with an aqueous nature of the sample. A vibrating tissue sectioning system is coupled to a microscope and is used to remove a region of the sample without moving the sample. The sectioning of the sample occurs under a surface of an aqueous buffer in a basin. A positioning system enables the microscope to image adjacent sub-regions of the sample. The microscope image multiple sections of the sample in adjacent subregions using the vibrating tissue sectioning system and the positioning system.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 60/963,763, filed on Aug. 7, 2007, by David S. Koos and Scott E. Fraser, entitled “Vibratome-Assisted-SubSurface-Imaging-Microscopy (VIBRA-SSIM) brings the advantages of fluorescent protein technology to extended 3-D volume imaging of large biological samples,” attorneys' docket number 176.39-US-P1 (CIT-4951-P).

### STATEMENT REGARDING FEDERALLY SPONSORED RESEARCH AND DEVELOPMENT

The U.S. Government has certain rights in this invention pursuant to Grant No. HD037105 awarded by the National Institutes of Health.

### BACKGROUND OF THE INVENTION

1. Field of the Invention

The present invention relates generally to three-dimensional (3D) volume imaging, and in particular, to a method, apparatus, and article of manufacture for 3D-volume imaging of biological samples.

2. Description of the Related Art

Determining the 3-D organization of whole biological samples is fundamental to understanding biological form and function. Unfortunately, prior art high-resolution imaging tools have very limited fields of view that are often much smaller than the region of interest. This presents a major obstacle since viewing a sample in its entirety at high-resolution is crucial to identifying interconnectivities and inter-dependencies within a sample. To overcome this obstacle, Extended 3-D Volume Imaging techniques have been developed in order to capture and visualize a sample in its entirety at high-resolution. This is done by imaging laterally-adjacent and vertically-adjacent sub-regions of a sample at high-resolution and then stitching those adjacent sub-regions together to form a composite high-resolution 3-D reconstruction representing the entire sample.

Block-based imaging schemes have emerged as the best approach for Extended 3-D Volume Imaging. Unfortunately, prior implementations of Block-Based Extended 3-D Volume Imaging employ an organic embedding procedure that is incompatible with the preservation of protein fluorescence. This is a major drawback because fluorescent protein technology is currently the state-of-the-art and most powerful method for highlighting proteins, cells, and organs. Accordingly, what is necessary is the ability to preserve protein fluorescence while providing extended 3-D volume imaging. These problems may be better understood with an explanation of prior art 3D representations and imaging techniques.

Challenges of Generating 3D Representations of Large Samples

Elucidating the detailed 3 dimensional (3-D) organization of biological tissues is fundamental to understanding biological form and function and for evaluating pathological states. 3-D reconstructions are ideally suited to the analysis of tissues and organs with complex structures where 2 dimensional views fail to give an adequate representation and mental visualization is difficult. 3-D reconstructions provide valuable insight into the interconnectivity and inter-dependencies within a sample. The ultimate utility of these 3-D datasets depends on the level of detail contained and the relative precision to which the original geometry is preserved in the resultant dataset.

Unfortunately, working limitations of current imaging tools dictate that as the region of interest (ROI) is increased in size, the level of imaging resolution must be decreased in order to fit the ROI into the field of view. Therefore, tools capable of imaging large organ sized samples in toto, such as MRI (magnetic resonance imaging) and CT (computed tomography), do so at relatively low resolution (tens of microns at best). Alternatively, laser-scanning microscopy (LSM) can provide sub-micron resolution optical sections of a sample. However physical limitations of optical imaging lead to a very small field of view (FOV) and thus only a small sub-region can be imaged at one time.

Extended 3-D Volume Imaging Overcomes a Limited Field of View

Extended 3-D Volume Imaging techniques have been developed to overcome the limited FOV associated with high-resolution optical imaging. These techniques all employ a basic plan of collecting high-resolution images of small sub-regions and then combining the sub-region images together to form a detailed composite image that represents the large sample in its entirety at high resolution. Two types of implementations of this technology have been employed: Section-Based and Block-Based.

Section-Based 3-D Volume Imaging

The Section-Based approach entails six (6) steps. The logical flow for the steps is set forth in FIG. 1. Images depicting the steps are set forth in FIGS. 2A-2F:

FIG. 2A illustrates a large biological sample 200. At step 100, the large sample 200 is sectioned to get large sections 202 as illustrated in FIG. 2B. To section the sample 200, large serial sections 202 are cut and collected throughout a large macroscopic sample 200.

At step 102, the entirety of each of the large sections 202 is imaged in the form of tiles T1-T12 as illustrated in FIG. 2C. To obtain tiled imaging of a single large section 202, adjacent lateral subregions (referred to as tiles) are optically imaged within each section 202 using either wide-field microscopy or laser scanning microscopy. This process is repeated on adjacent sub-regions until the entire region of interest in the large section 202 is completely covered by tiles T1-T12 of images. Each tiled sub-region overlaps its adjacent tiles T1-T12 by a small amount (10-30%) (see label 204) to ensure faithful image stitching.

At step 104, the tiles T1-T12 are stitched together and registered to make a sectional montage 206 as illustrated in FIG. 2D. In this regard, the tiles T1-T12 of lateral-adjacent subregions are stitched together to make a sectional montage 206 representing the entire section 202.

Once steps 102 and 104 have been completed for a large section 202, steps 102 and 104 are repeated for each large physical section 202 of the macroscopic sample 200. Such repetition is illustrated in FIG. 1 by determining whether an additional large section exists at step 106. Accordingly, the tiled imaging is repeated for each large section 202 and sectional montages 206 are prepared for each section 202.

At step 108, the sectional montages 206 are aligned/overlied and stitched together to generate a composite stack 208 as illustrated in FIG. 2E. In this regard, each sectional montage 206 is aligned with the its underlying sectional montage 206 and they are stitched together into one large composite stack 208 of sectional montages 206.

At step 110, the composite stack 208 of sectional montages 206 is reconstructed into a 3D volume 210 as illustrated in FIG. 2F. This composite stack 208 of sectional montages 206 can be computer reconstructed into a final 3D volume 210 that represents the entire sample 200 in 3D.

This tedious time consuming technique suffers from several drawbacks. First, because each section 202 is processed serially but separately, the original geometry and alignment of the tissue 200 is lost and therefore will require substantial effort to re-align or register (i.e., at step 108) the information in the section montages 206 prior generating the final 3D reconstruction 210. To further complicate the process, handling the sections 202 one by one often leads to physical distortions that alter the original tissue geometries 200. Finally, the physical act of sectioning (i.e., at step 100) destroys tissue at the sectioned surfaces. These destruction zones are lost data and will appear as gaps between the section montages 206 when they are combined into the final 3D reconstruction 210. These problems drastically reduce the effectiveness of section-based approaches for high resolution extended 3D volume imaging.

Block-Based 3-D Volume Imaging

Block-based approaches to extended 3D volume imaging have been developed in order to overcome the alignment problems and data loss associated with section-based approaches. Rather than cutting a macroscopic sample 200 into large sections 202 and then imaging those sections 202 separately one by one, block-based approaches image the surface of the macroscopic sample 200 while it is still connected to the underlying portion of the sample 200. In these block-based approaches, the sectioned face of the macroscopic sample 200 is tiled and imaged directly with either wide-field microscopy or laser scanning microscopy.

Once the entire block face has been tiled and all the laterally-adjacent subregions are imaged, those adjacent tiles can be stitched together to form a sectional montage. Thereafter, a set thickness of the sample is sectioned off and discarded. The exposed new surface is ready for the next round of tiled imaging and generation of the next sectional montage. The process is repeated until the entire macroscopic sample is represented by a stack of overlying sectional montages. Then the sectional montages are aligned into a composite stack that can be reconstructed into a high resolution 3D volume representing the entire macroscopic sample 200. Iterations of tiled imaging and sectioning maintains the alignment of the tissue throughout the resultant tiled stacks of optical sections. The preservation of alignment reduces the need to re-align prior to generating a 3D reconstruction and generally results in much better 3D reconstructions.

Laser Scanning Microscopy in Block-Based Extended 3-D Volume Imaging

One can assert that laser scanning microscopy is the better choice in block-based extended 3D volume imaging. The type of microscopic technique is an important consideration for block-based approaches to extended 3D volume imaging. Wide-field microscopic techniques will image the sample at the surface of the block. The sectioning induced destruction zones where data is physically lost will plague this method. These destruction zones will appear as gaps between the section montages when they are combined into the final 3D reconstruction. In addition wide-field imaging of the blockface will also collect image information from the sample underlying the blockface. In order to restrict the image information to only the block face the sample should be infiltrated with an opaque dye that will prevent the collection of information from below the blockface.

In view of the problems described above, one may elect to use laser-scanning microscopy (LSM) for block-based imaging. FIG. 3 illustrates the flow for performing block based extended 3D volume imaging using LSM. At step 302, LSM allows the user to image a stack of optical sections. LSMs can collect optical sections by either rejecting out of focus signals with a pinhole (confocal) or specifically exciting only a restricted spatial position (multiphoton). Because of the restricted optical section, these techniques do not need the sample to be infiltrated with an opaque dye. At step 304, the top of the stack of images can be set to begin below the sectioned and destroyed block surface (i.e., the upper portion of the block surface is removed). Furthermore, by imaging a stack of optical section that is larger in depth than the thickness of the section that is sectioned off and discarded—one can achieve overlapping stacks of optical sections. These overlapping stacks do not include images of the destroyed block surfaces and thus no gaps in the data will be encountered. The process of imaging followed the removal of the upper portions is repeated at steps 306-310 until the entire block surface has been imaged. At step 312, the internal structures are aligned and registered. At step 314, the internal structures are stitched together thereby reconstructing the 3D image.

Drawbacks of Previous Implementations of Block-Based Extended 3-D Volume Imaging

The previous Block-Based schemes also have drawbacks that limit their usefulness. Many block-based histological schemes infiltrate and embed the tissue sample in resin or plastic. Although the resin provides a very solid support for microtome sectioning, the infiltration process requires organic solvents that irreversibly alter the sample. Organic solvents cause macroscopic distortions, such as shrinkage, that change the original geometry of the tissue. In addition to altering the tissue geometry, organic solvents can also extract out cellular components and organelles. The second problem with organic processing required for resin embedding is that it is not compatible with fluorescent protein labeling technology.

Fluorescent proteins have become the favored means to molecularly highlight proteins, cells and organs. Fluorescent protein tags are genetically encodeable so no exogenous labels need to be applied. Furthermore, the availability of several distinct colors allows multiple cells or structures to be analyzed in the sample. Fluorescent proteins have already proven their effectiveness in studies of gene expression, protein localization, cell migration and brain connectivity. One weakness fluorescent protein technology is that the fluorescence of fluorescent proteins is very sensitive to exposure organic solvents. Therefore, in order to fully appreciate the value fluorescent proteins in Block-Based Extended 3-D Volume Imaging, it is necessary ensure that the processing does not destroy or quench the fluorescent proteins.

### SUMMARY OF THE INVENTION

One or more embodiments of the invention provides an aqueous block-based extended 3D volume imaging approach (referred to herein as Block-Based Extended 3-D Volume Imaging Vibratome-Assisted-SubSurface-Imaging-Microscopy [VIBRA-SSIM]) that is completely compatible with protein fluorescence and precisely maintains the original sample geometries. Embodiments of the invention allow the incorporation of the many advantages of fluorescent protein technology into Extended 3-D Volume Imaging of large biological samples in their entirety.

### BRIEF DESCRIPTION OF THE DRAWINGS

Referring now to the drawings in which like reference numbers represent corresponding parts throughout:

FIG. 1 illustrates the logical flow for a section based approach to 3D volume imaging of the prior art;

FIGS. 2A-2F illustrate images depicting the steps of FIG. 1 of the prior art;

FIG. 3 illustrates the flow for performing block based extended 3D volume imaging using laser scanning microscopy in the prior art;

FIG. 4 illustrates a schematic for vibratome assisted subsurface imaging microscopy in accordance with one or more embodiments of the invention;

FIG. 5 illustrates the logical flow for preparing a sample for imaging in accordance with one or more embodiments of the invention;

FIG. 6 illustrates the logical flow for conducting laser scanning microscope imaging in accordance with one or more embodiments of the invention;

FIG. 7 illustrates the logical flow for processing the imaged tiles in a computer in accordance with one or more embodiments of the invention; and

FIG. 8 is an exemplary computer hardware and software environment used to implement one or more embodiments of the invention.

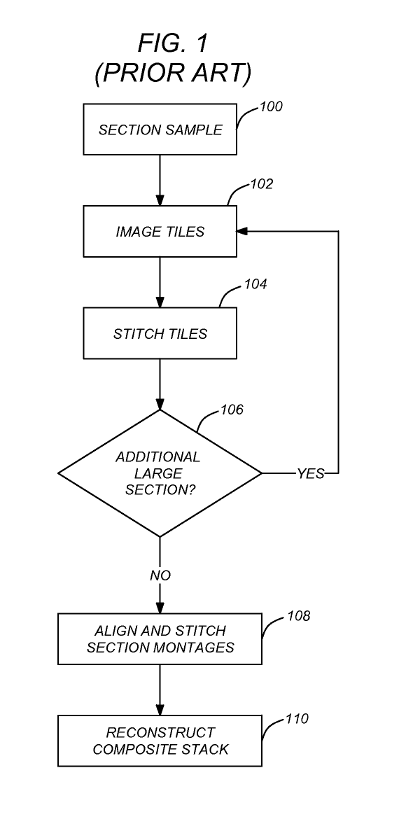

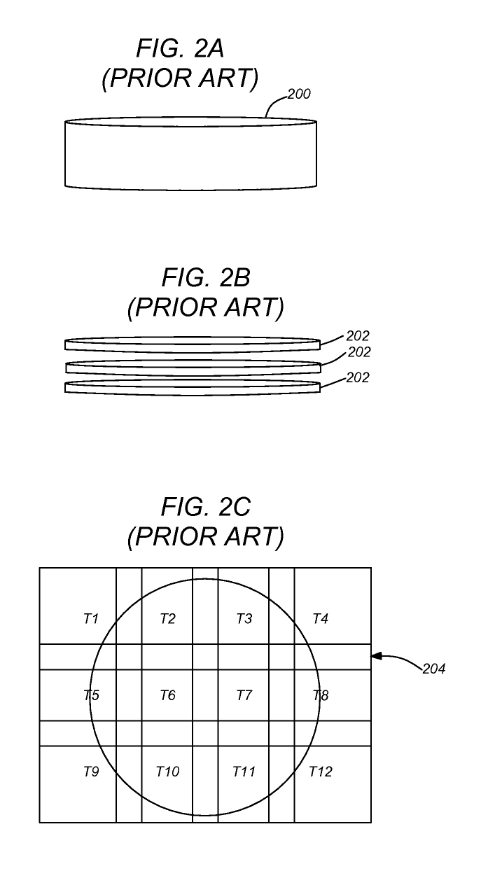

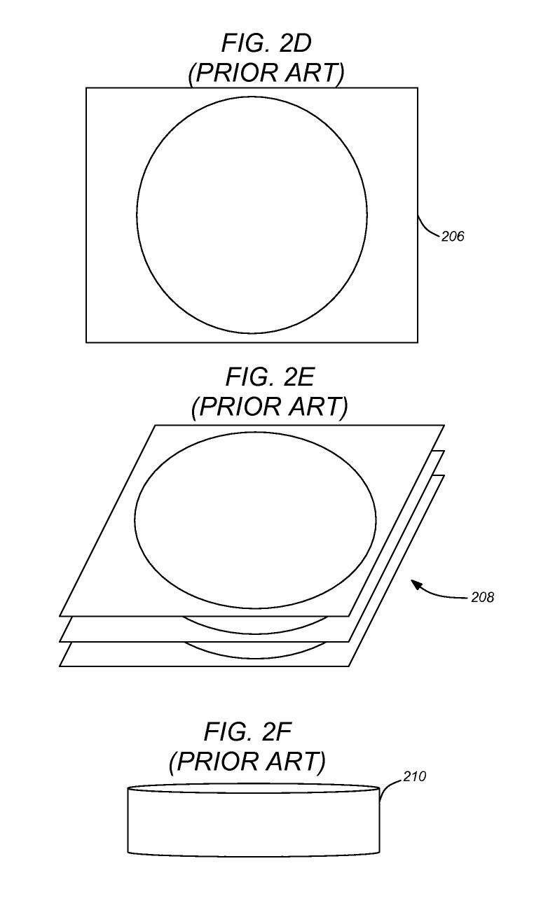

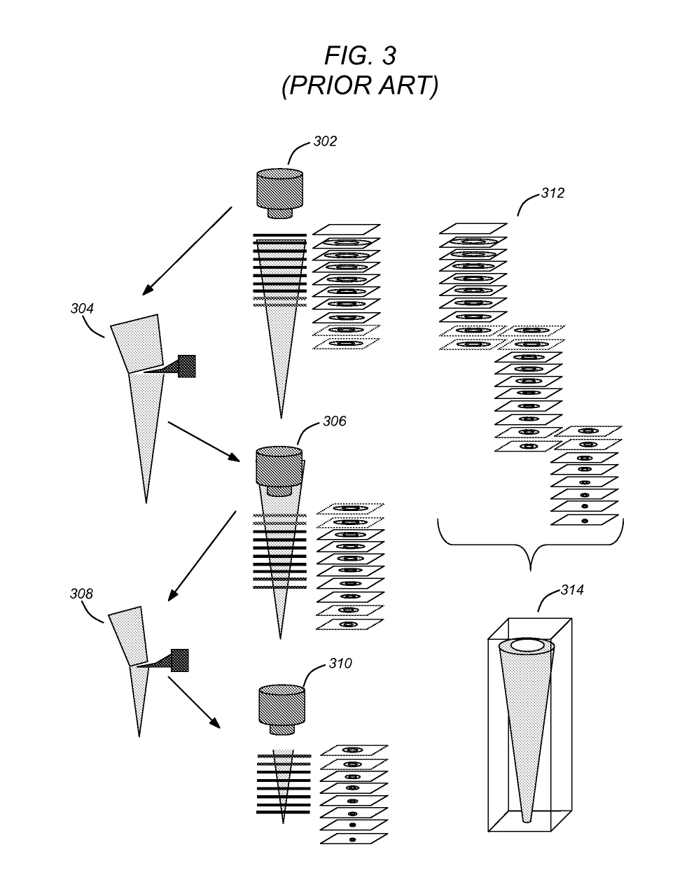

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

One or more embodiments of the invention provide a modified Block-Based Extended 3-D Volume Imaging device and methodology that overcomes the problems associated with prior approaches. Aqueous embedding and sectioning technologies are employed thereby completely avoiding the problems associated with organic processing. By avoiding organic processing, embodiments of the invention are completely compatible with fluorescent protein technology and samples maintain their native hydrated biological geometries. As used herein, embodiments of the invention employ a system and methodology referred to as Block-Based Extended 3-D Volume Imaging Vibratome-Assisted-SubSurface-Imaging-Microscopy (VIBRA-SSIM).

### Components and use of VIBRA-SSIM

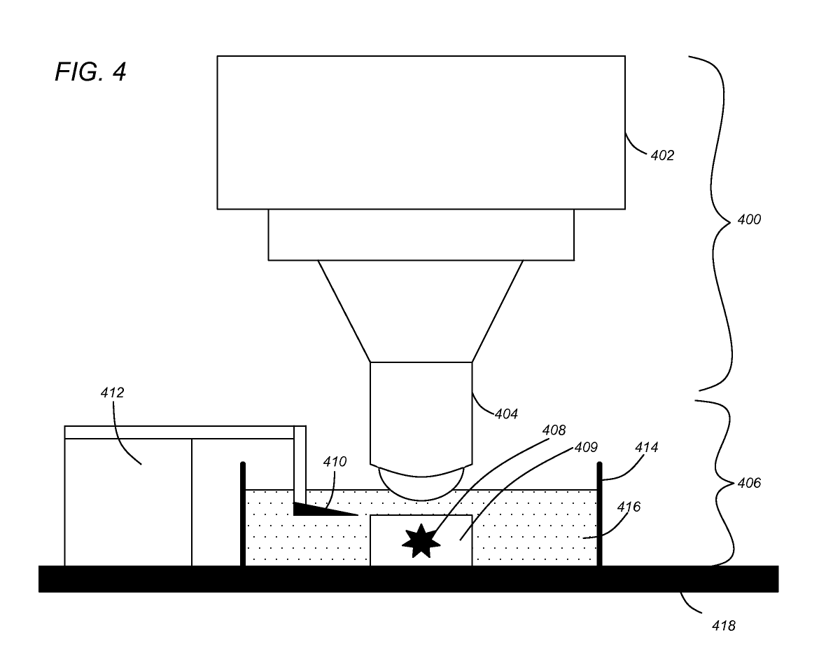

The basic design of VIBRA-SSIM is a laser-scanning microscope (LSM) coupled to a vibrating tissue sectioning system with an incorporated high precision X-Y positioning system. FIG. 4 illustrates a schematic for the VIBRA-SSIM in accordance with one or more embodiments of the invention.

### Microscope

The microscope or imaging 400 portion of VIBRA-SSIM can be either a Confocal or a Multiphoton laser-scanning microscope (CLSM or MPLSM respectively). Focus (referred to as imaging Z) of the LSM is achieved either by moving the entire LSM scan head 402 and objective 404 up and down or by employing a piezo stepper motor to move just the microscope objective 404 up and down. Alternatively, the entire cutting apparatus/shifting table 406 can be moved up and down for focus. Water immersion objectives 404 can be used to image the embedded sample 408 (see details below regarding the embedded sample).

Characteristics of the tissue/sample 408 may dictate several aspects of the vibra-sectioning procedure. Three considerations are: (1) the embedding matrix; (2) the type of knife or blade to be used; and (3) the parameters of the cutting process. Each of these considerations are discussed in detail herein.

### Sample Embedding and Mounting/Embedding Matrix

There are several options for sample embedding. In this regard, the sample 408 is embed into an embedding matrix 409. One feature of sample embedding is that rigid support should be provided for the sample 408 so that the sample 408 can be sectioned with moving the sample 408. The embedding matrix 409 should also be compatible with the aqueous nature of the sample 408 and buffer 416. Examples of embedding matrixes 409 may include 4%-7% low melt agarose prepared in an aqueous buffer or 4-14% acrylamide. It may be noted that agarose may hold the sample loosely whereas acrylamide holds firmly but requires increased user safety precautions. Further details regarding the sample 408 and embedding matrix 409 are discussed below.

The embedding matrix 409 serves two roles: (1) holds the sample 408 stable during the cutting process (e.g., when cast around the outer surface of the sample 408); and (2) supports delicate tissue that would normally collapse (e.g., when infiltrated into cavities and inter-cellular space.

Key Features of an Embedding Matrix 409

Key features of an embedding matrix 409 for the sample 408 may include rigidity, bio-compatibility, optical compatibility, setting parameters, secure sample hold, cleavability, and permeability.

Rigidity

The matrix 409 should be able to hold the sample 408 stable during the cutting process. An ideal matrix 409 will not flex or bend during forward force of the cutting process. In many cases the ideal stiffness of the matrix will closely approximate the stiffness of the tissue. In cases of very soft or delicate tissues the embedding matrix 409 will be more stiff than the sample 408.

Bio-Compatibility

The nature of the matrix 409 should be compatible with the tissue 408 and the labels applied or expressed by the tissue 408. In this regard, the matrix 409 should not perturb tissue geometry, should not perturb or extract cellular components and labels, and should not destroy or reduce the emission of fluorescent proteins.

Aqueous based matrix choices may be utilized as they avoid dehydration steps and organic extraction.

Optical Compatibility

The matrix 409 should be compatible with and not interfere with the form of laser scanning microscopy (LSM) to be used (e.g., low absorbance/scattering in visible light for Confocal LSM or low absorbance/scattering in infrared light for Multiphoton LSM). Very opaque light scattering matrix recipes that significantly block light penetration may not be suitable.

Setting Parameters

Casting and set up of the matrix 409 around the tissue sample 408 should not exhibit features that will destroy or alter the sample 408. Matrix recipes involving high temperatures may not be suitable.

Secure Sample Hold

An ideal matrix 409 may adhere to the tissue 408 or fill into nook and crannies of the tissue 408. This tight linkage of the matrix 409 to the tissue sample 408 may be required to establish stability of the sample 408 during the cutting process.

The hold of the matrix 409 on the sample 408 can be enhanced in a number of ways. Soaking the tissue sample 408 in the matrix components prior to allowing matrix solidification can enhance the infiltration of the matrix 409 into the crannies of the tissue 408 surface.

Alternatively, once the tissue 408 has been embedded in the matrix 409, the block of matrix 409 can be soaked in a cross-linking fixative such as 4% paraformaldyhyde in a suitable aqueous buffer. This post fixation can cross link the matrix 409 to the sample 408 and enhance the stability of the hold.

Cleavability

The matrix 409 should be compatible with and cleavable by the type of knife used. Matrix recipes that can not be cut by a metal blade, sapphire knife or glass blade may not be effective.

Permeability

The matrix 409 should be aqueous buffer permeable. Buffer diffused in to the matrix/sample block helps preserve the tissue 408 by keeping it hydrated, lubricates the blade during cutting, and reduces heat build-up.

Sample Matrices

Various matrices have been found to be useful to satisfy the features described above.

Low Melt Agarose (LMA)

A low melt-agarose (LMA) may be suitable as an embedding matrix 409 when made up in a physiological appropriate buffer. Such a matrix 409 may include Agarose concentrations of 4% w/v (weight/volume percentage solution) and will provide adequate support for most tissue. However, the agarose concentrations can be increased or decreased to match the tissue features. Once prepared, LMA remelts @ 65 c and gels @ 28 c. Therefore molten LMA solutions can be held at 37-42 c and won't gel. These physiologically appropriate temperatures are compatible with many tissue types and labels and will not destroy or perturb the tissue or the molecular labels used to highlight specific cellular structures and cellular components.

Such a matrix 409 allows the user to soak the tissue sample 408 in the molten LMA allowing for enhanced infiltration in to the crevices/cavities of the tissue 408. Once cooled to room temperature or colder the LMA gels solid with altering the tissue.

Gelatin

Another matrix 409 consists of gelatin made up in a physiological appropriate buffer. A gelatin with 300 bloom viscosity may be suitable but other viscosities may be used. A 7% w/v solution may also be used but the concentration can be adjusted to make a desired stiffness. Gelatin solutions melt>50 c and gels around 28 c. As with agar, this feature of being molten at compatible temperature allows the user to infiltrate the matrix into the crevices/cavities of the tissue.

Acrylamide

Acrylamide can also be used as a matrix 409. Such a matrix 409 may consist of a mixture of Acrylamide and Bisacrylamide. Varying the ratio of the two compounds one can make a matrix 409 with differing rigidity. The acrylamide can be polymerized by the addition of Ammonium persulfate (APS). The tissue sample 408 can be soaked in the acrylamides with out (APS) so as to allow for enhanced infiltration into the tissue crevices/cavities and intercellular spaces. Once infiltrated, the APS can be added to polymerize the matrix.

The polymerization of acrylamide is strongly exothermic and may need to be performed in the cold in order to prevent destroying the tissue. Further, acrylamide polymerization may be inhibited by exposure to air, so some form of seal should be used to reduce air exposure.

### Vibrating Tissue Sectioning System

A vibrating tissue sectioning system 406 (often referred to as a Vibratome) is used to remove the upper regions of the sample 408 (also referred to as sample block). The vibrating action of the blade 410 as it progresses through the sample 408 allows for clean cutting without distorting the sample 408.

The type of knife or blade 410 to be used may affect the vibra-sectioning procedure. Two types of blades 410 are commonly used. The blade type is chosen based on the tissue characteristics and the thickness of the section to be cut. Other types of blades can be used.

Metal razor blades are most commonly used, inexpensive, and disposable. metal razor blades are good for most soft tissue types (embryos, brain tissue), they dull easily, an are good for sections>50 um but they don not perform well for thinner sections.

Sapphire blades are very sharp, expensive, and can be re-sharpened. Sapphire blades are good for rubbery tissue (e.g., connective tissue), hard tissue (e.g., cartilage), and for thin sections in the 20 um range. Thus, a sapphire knife allows for sections as thin as 20 microns or less to be removed where as a metal razor blade is used for sections greater than 50 microns.

As described above, another consideration that may affect the vibra-sectioning procedure is that of the parameters of the cutting process. Vibra-sectioning has 2 basic parameters (1) oscillation amplitude; and (2) forward advance rate.

Oscillation amplitude refers to the sawing motion of the knife/blade 410. In general, a higher amplitude reduces binding and cuts better, especially for tough, or hard to cut samples 408. Delicate tissues 408 are also better cut with a high amplitude. Thin sections are better with high amplitude.

Forward advance is the speed that the oscillating knife 410 is pushed forward. Too fast of forward advance will tear the tissue 408 rather than allowing the blade 410 to cut. In general, the tougher (rubbery) the tissue 408, the slower the advance rate to be used. Delicate tissues 408 are also better cut with a slow advance.

Cutting parameters need to be optimized for each type of tissue sample.

With the above in mind, the vibra-sectioning system 406 may be optimized accordingly. One implementation of the vibrating tissue sectioning system 406 holds the blade 410 at a set height. The tissue block (sample z) 408 is moved up by a set amount by the sample Z controller 412 and then the blade 410 is moved forward to remove that thickness of block 408. In this manner the cut top of the tissue block 408 is always at the same position. Accordingly, the vibrating tissue sectioning system 406 provides a knife motor 412 which controls the oscillation and horizontal translation of the blade 410 that is cutting the sample block 408.

The vibrating tissue sectioning system 406 has a basin 414 into which the sample block 408 is mounted to the stage. The basin 414 is filled with aqueous buffer 416 completely submerging the stage and tissue block 408. Block sectioning occurs under the buffer 416 surface so the sample 408 always stays hydrated.

### High Precision X-Y Positioning System

The instrument 418 (e.g., a shifting table) used to position the sample 408 should be able to image adjacent sub-regions (movements in the X and Y axes). Movements in X and Y can be driven in at least 2 ways. A first option is to place the entire vibrating tissue sectioning system 406 on an X-Y positioning system (e.g., the shifting table 418). In other words, the sectioning system 406 or x-y positioning units 418 are moved. Alternatively, the imaging mechanism 400 can be moved. In such an embodiment, the microscope scan head 402 can be attached to an X-Y positioning system (not shown). In one or more embodiments, the positioning system 418 is highly precise. In this regard, failure to reposition correctly may lead to a loss of sample alignment and can complicate 3-D reconstruction.

### Automation

The entire reiterative process of imaging adjacent regions and removing the top of the block can be automated.

Basic Plan of Block-Based Extended 3-D Volume Imaging Using VIBRA-SSIM:

Preparation

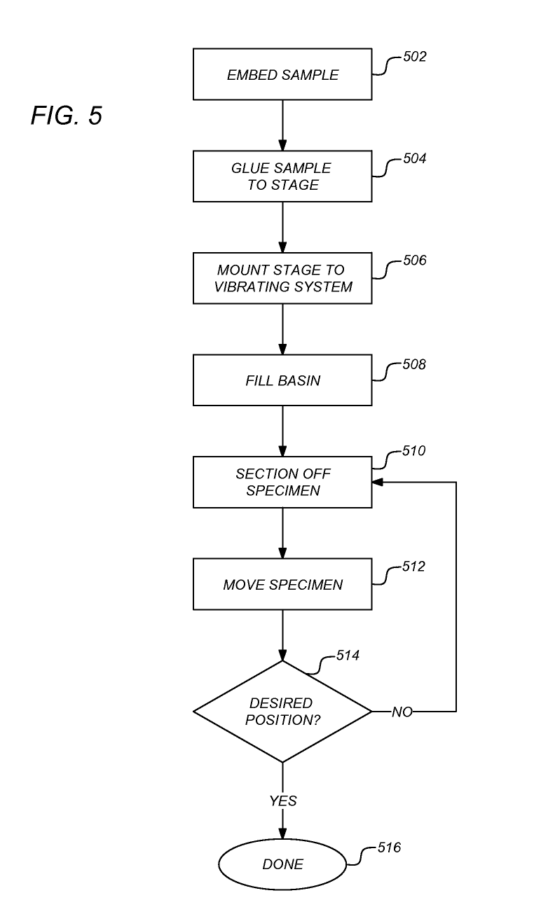

FIG. 5 illustrates the logical flow for preparing a sample 408 for imaging in accordance with one or more embodiments of the invention.

At step 502, the sample 408, is embed in the appropriate matrix 409 (low melt agarose or acrylamide).

At step 504, the embedded sample 408 is glued in its matrix block 409 to the specimen stage.

At step 506, the specimen stage with the blocked specimen 408 is mounted to the vibrating tissue sectioning system 406 chuck in the basin 414.

At step 508, the basin 414 is filled with an aqueous buffer 416.

At step 510, the top of the specimen block 408 is sectioned off.

At step 512, the specimen 408 is moved up via/using the sample controller.

At step 514, a determination is made regarding whether the sample 408 is in the desired position. If not, the process repeats beginning with step 510. If the sample 408 is at the desired position, the preparation process is complete at step 516.

LSM Imaging

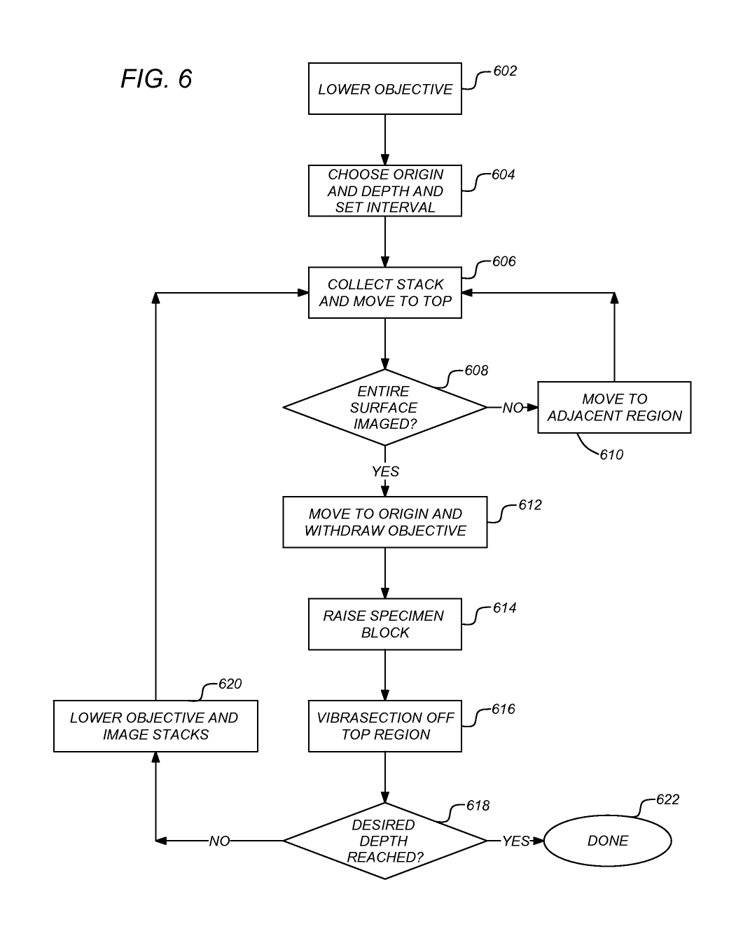

FIG. 6 illustrates the logical flow for conducting laser scanning microscope imaging in accordance with one or more embodiments of the invention.

At step 602, the microscope objective 404 is lowered into imaging range of the upper region of the block 408 (imaging Z origin).

At step 604, the X-Y origin where collection will begin and the overall depth of imaging volume (total imaging Z) is chosen/selected. Further, based on such selections, the appropriate interval of optical section acquisition is set/established.

At step 606, the first stack of optical sections is collected and the microscope objective 404 is moved back to the top of image Z. In other words, the microscope focus position is moved to a top of the imaging volume;

At step 608, a determination is made regarding whether an entire sample surface region has been imaged in tiles of adjacent stacks. Such tiles of adjacent stacks represent the entire level of the sample.

If the entire surface has not yet been imaged, the X-Y controller 418 is used to move the sample 408 to a laterally-adjacent region or tile at step 610 and the process continues back at step 606 (i.e., the optical section stack collection process is repeated).

Once the entire surface has been imaged, the sample 408 is moved back to the X-Y origin and the microscope objective 404 is withdrawn at step 612.

At step 614, the specimen block 408 (sample Z) is raised up in an interval less than the total imaging Z.

At step 616, a set thickness of the top region of the block 408 is vibrasectioned off (e.g., using system 406).

At step 618, a determination is made regarding whether the desired macroscopic depth of the sample 408 has been reached.

If the desired depth has not yet been reached, the microscope objective 404 is lowered to the imaging Z origin and the tiled imaging of laterally adjacent optical stacks is repeated at 620 and continuing with step 606.

Once the desired macroscopic depth of the sample 408 has been reached the imaging process is complete at step 622.

Computer Processing

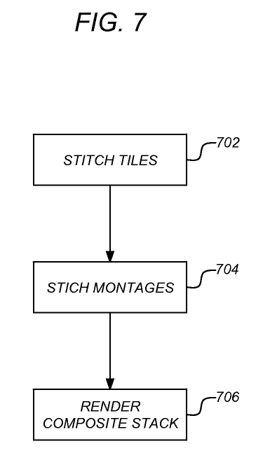

FIG. 7 illustrates the logical flow for processing the imaged tiles in a computer in accordance with one or more embodiments of the invention.

At step 702, the tiles of adjacent stacks of each level are stitched together in a computer to make a sectional montage.

At step 704, each sectional montage is stitched together with the previous sectional montage to generate a composite stack of section montages.

At step 706, the composite stack of sectional montages is rendered into a 3-D volume representing the entire macroscopic sample.

Uses

High-resolution extended-volume 3-D reconstructions are useful for all areas of life sciences because they allow the researcher to visualize large complicated samples in a range of scales from molecule to organ. Identifying dependencies and interconnectivities are much easier to appreciate when the entire sample is visualized and as opposed to isolated small regions. Some of the disciplines that may immediately benefit from embodiments of the invention are neuroanatomy, surgical guidance, pathology and pathologic evaluation and developmental biology.

### Hardware Environment

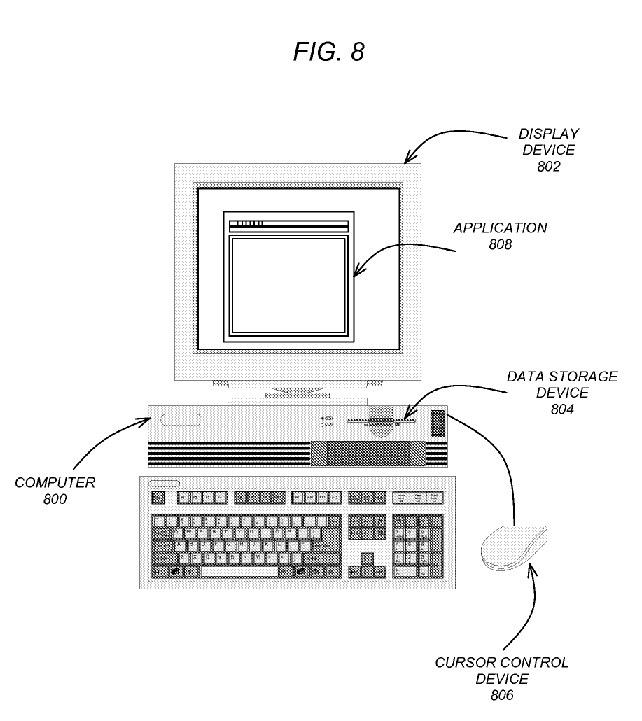

FIG. 8 is an exemplary computer hardware and software environment used to implement one or more embodiments of the invention. Embodiments of the invention are typically implemented using a computer 800, which generally includes, inter alia, a display device 802, data storage devices 804, cursor control devices 806, and other devices. Those skilled in the art will recognize that any combination of the above components, or any number of different components, peripherals, and other devices, may be used with the computer 800.

One or more embodiments of the invention are implemented by an application 808 (e.g., to perform the steps of FIG. 7), wherein the application may be represented by a window displayed on the display device 802. Such a window may represented the rendered composite stack produced in FIG. 7. Generally, the application 808 comprises logic and/or data embodied in or readable from a device, media, carrier, or signal, e.g., one or more fixed and/or removable data storage devices 804 connected directly or indirectly to the computer 800, one or more remote devices coupled to the computer 800 via a data communications device, etc.

In one or more embodiments, instructions implementing the application 808 are tangibly embodied in a computer-readable medium, e.g., data storage device 804, which could include one or more fixed or removable data storage devices, such as a zip drive, floppy disc drive, hard drive, CD-ROM drive, tape drive, etc. Further, the application 808 is comprised of instructions which, when read and executed by the computer 800, causes the computer 800 to perform the steps necessary to implement and/or use the present invention. Application 808 and/or operating instructions may also be tangibly embodied in a memory and/or data communications devices of computer 800, thereby making a computer program product or article of manufacture according to the invention. As such, the terms “article of manufacture” and “computer program product” as used herein are intended to encompass a computer program accessible from any computer readable device or media.

Those skilled in the art will recognize that the exemplary environment illustrated in FIG. 8 is not intended to limit the present invention. Indeed, those skilled in the art will recognize that other alternative environments may be used without departing from the scope of the present invention.

### Conclusion

This concludes the description of the preferred embodiment of the invention. The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. An imaging system comprising:
(a) a sample embedded to a support matrix, wherein:
(i) the sample can be sectioned without movement; and
(ii) the support matrix is compatible with an aqueous nature of the sample;
(b) a vibrating tissue sectioning system that is coupled to a microscope, wherein:
(i) the vibrating tissue sectioning system is used to remove a region of the sample;
(ii) the vibrating tissue sectioning system comprises a basin, wherein:
(1) the basin is filled with an aqueous buffer in which the sample is placed; and
(2) sectioning occurs under a surface of the aqueous buffer;
(c) a positioning system that provides an ability for the microscope to image adjacent sub-regions of the sample; and
(d) the microscope used to image multiple sections of the sample in adjacent subregions using the vibrating tissue sectioning system and the positioning system.

2. The system of claim 1 wherein the vibrating tissue sectioning system is placed onto the positioning system to drive the imaging of adjacent sub-regions.

3. The system of claim 1 wherein a scan head of the microscope is attached to the positioning system to drive the imaging of adjacent sub-regions.

4. The system of claim 1 further comprising a computer configured to:
stitch together tiles of adjacent stacks of the imaged multiple sections to create a sectional montage;
stitch multiple sectional montages together to generate a composite stack of sectional montages; and
render the composite stack of sectional montages into a 3D volume representing the sample.

5. The system of claim 1 wherein the microscope is used to image multiple sections by:
(a) lowering an objective of the microscope into imaging range of an upper region of the sample;
(b) selecting an x-y origin where collection will begin;
(c) selecting an overall depth of imaging volume;
(d) setting an interval of optical selection acquisition;
(e) imaging a stack of optical sections of the sample;
(f) moving a microscope focus position to a top of the imaging volume;
(g) determining whether entire sample surface region has been imaged;
(h) if entire sample surface has not been imaged, using the positioning system to move the sample to a laterally-adjacent region and continuing at step (e);
(i) if the entire sample surface has been imaged:
(i) using the positioning system to move the sample back to the x-y origin;
(ii) withdraw the objective of the microscope;
(iii) raising sample up the interval;
(iv) vibrasectioning off a top region of the sample; and
(v) if the desired depth has not been reached, lowering the objective of the microscope and continuing at step (e).

6. The system of claim 1 wherein the sectioning is performed using a metal razor blade.

7. The system of claim 1 wherein the sectioning is performed using a sapphire blade.

8. The system of claim 1 wherein the sample is embedded to the support matrix by soaking the sample into components of the matrix.

9. The system of claim 1 wherein an oscillation amplitude and forward advance rate of the vibrating tissue sectioning system are optimized based on the sample.

10. A method for imaging a biological sample, comprising:
(a) embedding a sample to a support matrix, wherein
(i) the sample can be sectioned without movement; and
(ii) the support matrix is compatible with an aqueous nature of the sample;
(b) placing the sample embed in the support matrix into a basin filled with an aqueous buffer, wherein:
(i) the basin is part of a vibrating tissue section system; and
(ii) the vibrating tissue sectioning system is used to remove a region of the sample;
(iii) the sectioning occurs under a surface of the aqueous buffer;
(c) positioning the sample into a position where a microscope can image adjacent sub-regions of the sample; and
(d) a microscope imaging multiple sections of the sample in adjacent subregions using the vibrating tissue sectioning system and the positioning system.

11. The method of claim 10 wherein the vibrating tissue sectioning system is placed onto the positioning system to drive the imaging of adjacent sub-regions.

12. The method of claim 10 wherein a scan head of the microscope is attached to the positioning system to drive the imaging of adjacent sub-regions.

13. The method of claim 10 further comprising a computer configured to:
stitch together tiles of adjacent stacks of the imaged multiple sections to create a sectional montage;
stitch multiple sectional montages together to generate a composite stack of sectional montages; and
render the composite stack of sectional montages into a 3D volume representing the sample.

14. The method of claim 10 wherein the microscope is used to image multiple sections by:
(a) lowering an objective of the microscope into imaging range of an upper region of the sample;
(b) selecting an x-y origin where collection will begin;
(c) selecting an overall depth of imaging volume;
(d) setting an interval of optical selection acquisition;
(e) imaging a stack of optical sections of the sample;
(f) moving a microscope focus position to a top of the imaging volume;
(g) determining whether entire sample surface region has been imaged;
(h) if entire sample surface has not been imaged, using the positioning system to move the sample to a laterally-adjacent region and continuing at step (e);
(i) if the entire sample surface has been imaged:
(i) using the positioning system to move the sample back to the x-y origin;
(ii) withdraw the objective of the microscope;
(iii) raising sample up the interval;
(iv) vibrasectioning off a top region of the sample; and
(v) if the desired depth has not been reached, lowering the objective of the microscope and continuing at step (e).

15. The method of claim 10 wherein the sectioning is performed using a metal razor blade.

16. The method of claim 10 wherein the sectioning is performed using a sapphire blade.

17. The method of claim 10 wherein the sample is embedded to the support matrix by soaking the sample into components of the matrix.

18. The method of claim 10 further comprising optimizing an oscillation amplitude and forward advance rate of the vibrating tissue sectioning system based on the sample.
